(19) United States
(12) Patent Application Publication
(10) Pub. No.: US 2021/0303272 A1
(43) Pub. Date: Sep. 30, 2021

(54) LEARNING STRING EDIT ACTIONS FROM REPAIR EXAMPLES OF SOFTWARE PROGRAMS

(71) Applicant: FUJITSU LIMITED, Kawasaki-shi (JP)

(72) Inventors: Hiroaki YOSHIDA, Cupertino, CA (US); Mukul R PRASAD, San Jose, CA (US)

(73) Assignee: FUJITSU LIMITED, Kawasaki-shi (JP)

(21) Appl. No.: 16/835,372

(22) Filed: Mar. 31, 2020

(51) Int. Cl. G06F 8/33; G06F 16/901

(52) U.S. Cl. CPC G06F 8/33; G06F 16/9024

(57) ABSTRACT

In an embodiment, operations may include identifying at least one first string in a first repair example to repair a first violation of a first software program and identifying at least one second string in a second repair example to repair a second violation of a second software program. The first and second violations may be string-related violations. The operations may include generating a first set of string edit actions for the first software program based on the at least one first string and the first violation, and generating a second set of string edit actions for the second software program based on the at least one second string and the second violation. The operations may include determining one or more common string edit actions based on the first and second sets of string edit actions and repairing a string-related violation based on the one or more common edit actions.

### FIELD

The embodiments discussed in the present disclosure are related to learning string edit actions from repair examples of software programs.

### BACKGROUND

Many new technologies for software programs are being developed to identify and flag suspicious code patterns that can affect performance, correctness of software program or violate style guidelines for a project. The suspicious code patterns or violations may not only affect operations to be performed by the software programs but may also affect overall development time of the software programs. Certain solutions have been developed to repair different violations identified from various software programs in different domains. Such solutions are being referred as repair examples to repair or resolve the corresponding violations. The repair examples may refer to a sequence of operations, such as edit actions, that may be required to be applied on the corresponding violations to generate a repaired program.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, operations may include identifying at least one first string in a first repair example and at least one second string in a second repair example. The first repair example may be configured to repair a first violation of a first software program, and the second repair example may be configured to repair a second violation of a second software program. The first violation and the second violation may be string-related violations. The operations may further include generating a first set of string edit actions for the first software program based on the identified at least one first string in the first repair example and the first violation. The operations may further include generating a second set of string edit actions for the second software program based on the identified at least one second string in the second repair example and the second violation. The operations may further include determining one or more common string edit actions based on the generated first set of string edit actions and the generated second set of string edit actions. The operations may further include applying the determined one or more common string edit actions on a string-related third violation of a third software program to generate a repaired third software program.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to learning one or more string edit actions from repair examples of software programs;

FIG. 2 is a block diagram that illustrates an exemplary electronic device for learning one or more string edit actions from repair examples of software programs;

FIG. 3 illustrates an exemplary repair example of a software program including a violation and a repaired software program;

FIG. 4 illustrates exemplary edit operations/actions including string-related edit operations/actions to repair a defected software program based on an improved software program;

FIG. 5A and FIG. 5B, collectively, illustrate an example of a graph associated with a set of string edit action sequences and illustrates an example of string edit action sequence to repair a string-related violation;

FIG. 6 illustrates an example of a scenario of a learning one or more string edit actions from repair examples of software programs;

FIG. 7 illustrates an example of a scenario of learning one or more string edit actions from edit script graphs of software programs;

FIG. 8 is a flowchart of an example method for repair of string-related violations of software programs; and

FIG. 9 is a flowchart of an example method for generation of an edit script graph based on a repair example for a string-related violation of a software program,

all according to at least one embodiment described in the present disclosure.

### DESCRIPTION OF EMBODIMENTS

Some embodiments described in the present disclosure relate to learning one or more string edit actions from repair examples of software programs. Typically, software programs are developed in different domain specific languages to provide variety of solutions. During development or deployment of the software programs, several issues (e.g. faults, bugs, suspicious code, or violations) may be detected. These issues may not only affect the required operation or performance of the software program but may also affect overall time for completion of development of the software program.

Certain static analyzer or static code analysis tools are available to automatically detect different violations in the software programs. These static code analysis tools may detect one or more syntax violations and/or semantic violations. These static code analysis tools may detect different attributes (for example type, line numbers, node name, or node attributes) of the identified violations. Further, these static code analysis tools may also detect stylistic violations, common software weaknesses, security vulnerabilities, and/or other style guidelines violations. Example of the static code analyzer or static code analysis tools may include, but are not limited to, FindBugs, SpotBugs, PMD, Coverity, Facebook Infer, Google error-prone, SonarQube, Splint, cppcheck or Clang static analyzer. Such static code analysis tools may automatically detect violations in software programs in different domain specific languages (DSL).

Typically, repair operations or modifications may be used to repair the violations of a software program and transform a defective software program into an improved software program (or a repair example). Certain solutions were developed, which considered several repair operations, as repair examples, to automatically learn and generate repair strategies (or common repair patterns) through different learning techniques (for example, machine learning). Such solutions are referred as “programming by example (PbE)” based repair pattern learning or generation systems. For example, FLA18-007 U.S. patent application Ser. No. 16/109,434 filed on Aug. 22, 2018, which is incorporated by reference herein in its entirety, discuss the generation and learning of fix patterns (hereinafter referred to as repair patterns) based on different detected defects (i.e. violations) in one or more software programs and based on edit operations/actions (i.e. repair examples) associated with the detected defects. It may be noted that methods to generate the fix pattern (or repair pattern) by the referenced application are merely an example. Although, there may be different other ways to generate or learn the repair patterns based on different repair examples or edit operations/actions performed to repair of the violations.

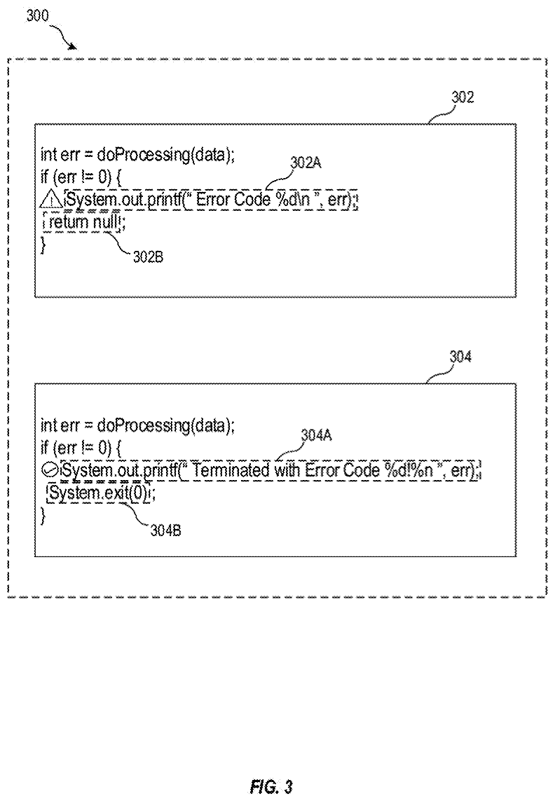

The generated repair patterns may be used to perform repair operations on the defected software program. The repair patterns may also correspond to, generalize, or represent one or more edit operations/actions (as repair examples) performed on the detected violations to repair the detected violations or to obtain repaired software programs. Similarly, several improved software programs may be used to identify one or more edit operations/actions with respect to different defective software programs (including violations) to learn or generate different repair patterns. The repair pattern may be generated in a format which may be compatible with a source code of the software program, including the violation repaired using the repair pattern. An example of a violation and a repair example of a software program is described in detail, for example, in FIG. 3.

The generated repair patterns may be able to repair certain reported violations. However, conventional techniques may not be able to identify string-related violations of software programs as typical program differencing tools may not be able to perform fine-grained analysis of certain differences between strings in defected programs (i.e., violations) and repair examples of the defected programs. Thus, in order to resolve different string-related violations and learn repair patterns for string-related violations, an improvement of the automatically generated repair patterns is required.

According to one or more embodiments of the present disclosure, the technological field of software project management, including software security, software debugging, software verification and validation (V&V) may be improved by configuring a computing system in a manner in which the computing system is able to identify a string related-violation in a defected software program and generate an enhanced string edit script for the string related-violation.

The system may be configured to identify at least one first string in a first repair example and at least one second string in a second repair example. The first repair example may be configured to repair a first violation of a first software program, and the second repair example may be configured to repair a second violation of a second software program. The first violation and the second violation may be string-related violations. The system may be further configured to generate a first set of string edit actions for the first software program based on the identified at least one first string in the first repair example and the first violation. Similarly, the system may be configured to generate a second set of string edit actions for the second software program based on the identified at least one second string in the second repair example and the second violation. Further, the system may be configured to determine one or more common string edit actions based on the generated first set of string edit actions and the generated second set of string edit actions. The system may be configured to apply the determined one or more common string edit actions on a string-related third violation of a third software program to generate a repaired third software program. The determined one or more common string edit actions may represent a common solution (or repair patterns for string-related violations) that may be learnt to repair a string-related violation of a certain type in software programs. Thus, a new string related-violation of another software program may be effectively repaired based on the determined one or more common string edit actions.

Embodiments of the present disclosure are explained with reference to the accompanying drawings.

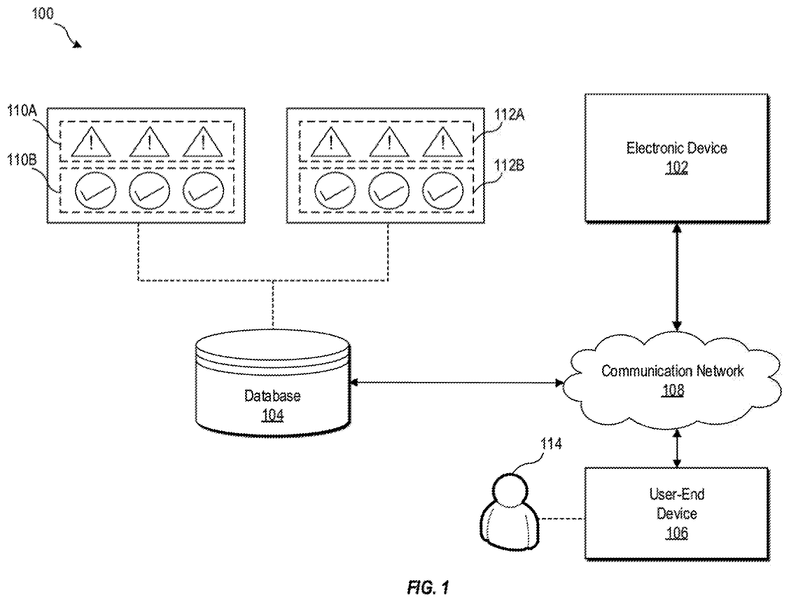

FIG. 1 is a diagram representing an example environment related to learning one or more string edit actions from repair examples of software programs, arranged in accordance with at least one embodiment described in the present disclosure. With reference to FIG. 1, there is shown an environment 100. The environment 100 may include an electronic device 102, a database 104, a user-end device 106, and a communication network 108. The electronic device 102, the database 104, and the user-end device 106 may be communicatively coupled to each other, via the communication network 108. In FIG. 1, there is further shown a first set of violations 110A of a first software program and a first set of repair examples 110B of the first software program that may be stored in the database 104. Similarly, for a second software program, the database 104 may store a second set of violations 112A and a second set of repair examples 112B of the second software program. There is further shown a user 114 who may be associated with or operating the electronic device 102 or the user-end device 106. The user 114 may be a person with software development, debugging, or testing experience.

The electronic device 102 may comprise suitable logic, circuitry, interfaces, and/or code that may be configured to retrieve a first repair example from the first set of repair examples 110B of the first software program from the database 104. The electronic device 102 may further retrieve a second repair example from the second set of repair examples 112B of the second software program from the database 104. The first repair example may be configured to repair a first violation of the first software program and the second repair example may be configured to repair a second violation of the second software program.

The first set of violations 110A and the second set of violations 112A may correspond to faults or bugs detected from the first software program and the second software program, respectively, by various static code analysis tools known in the art. In an embodiment, each of the first violation and the second violation may be a string-related violation. Examples of string-related violations, their descriptions, and sample repair examples are provided in Table 1, as follows:

TABLE 1
Example String-related Violations, their Descriptions, and Repair Examples

| String-related violations and descriptions | Sample repair examples |
|---|---|
| ... | ... |
| System.out.printf(“Error Code %d\n”, err); | System.out.printf(“Error |
| ... | Code %d%n”, err); |
| Description: Use of a new line in string output | ... |
| (VA_FORMAT_STRING_USES_NEWLINE) | |
| ... | ... |
| System.out.printf(“Error Code %l%n”, err); | System.out.printf(“Error |
| ... | Code %d%n”, err); |
| Description: Illegal string format | ... |
| (VA_FORMAT_STRING_ILLEGAL) | |
| ... | System.out.printf(“Error |
| System.out.printf(“Error Code { }%n”, err); | Code %d%n”, err); |
| ... | |
| Description: Extra arguments in a string | |
| (VA_FORMAT_STRING_EXTRA_ARGUMENTS_PASSED) | |
| ... | ... |
| class myClassName | class MyClassName |
| ... | ... |
| Description: Incorrect class naming convention | |
| (NM_CLASS_NAMING_CONVENTION) | |
| ... | ... |
| int MyMethodName(...){ | int myMethodName(...) { |
| ... | ... |
| Description: Incorrect method naming convention | |
| (NM_METHOD_NAMING_CONVENTION) | |
| ... | ... |
| double MyFieldName; | double myFieldName; |
| ... | ... |
| Description: Incorrect variable naming convention | |
| (NM_FIELD_NAMING_CONVENTION) | |

As shown in Table 1, examples of string-related violations may include, but are not limited to, a new line in a string output, an illegal string format, an extra argument in a string, an incorrect class naming convention, an incorrect method naming convention, or an incorrect variable/field naming convention. It should be noted that data provided in Table 1 may merely be taken as experimental data and may not be construed as limiting the present disclosure.

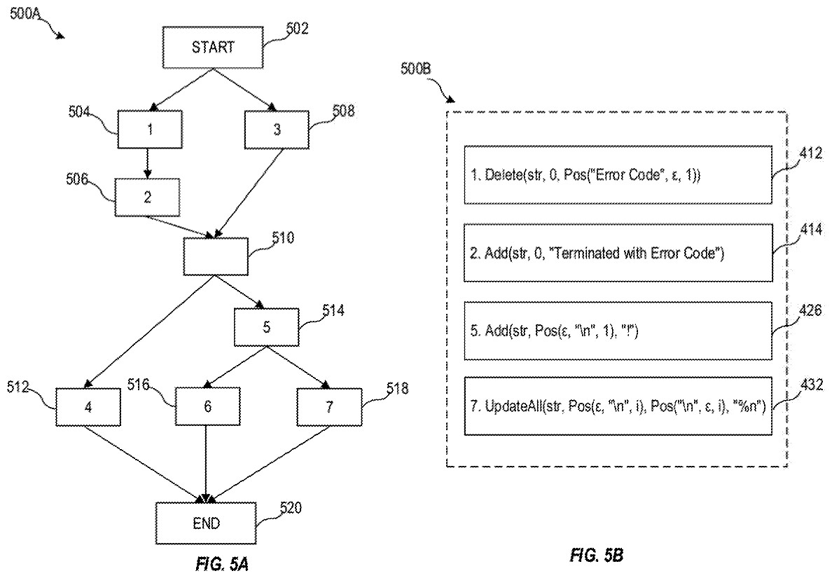

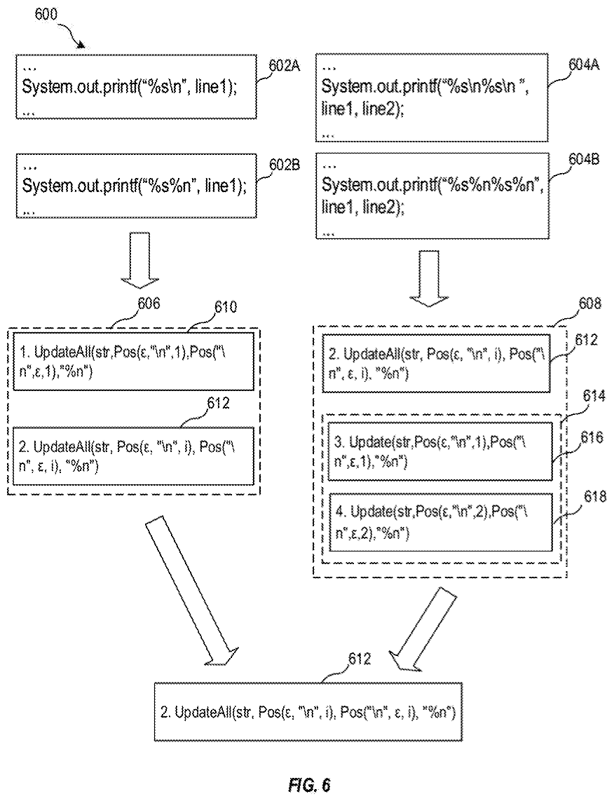

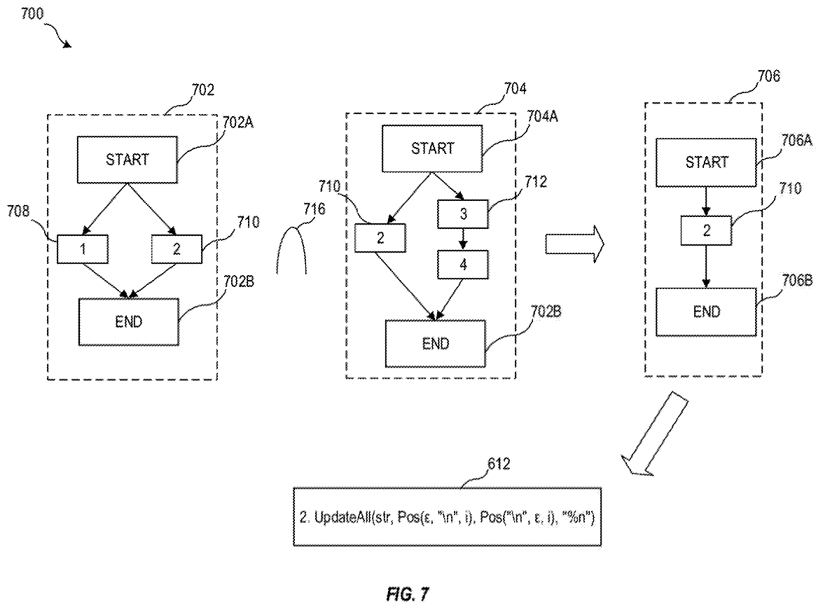

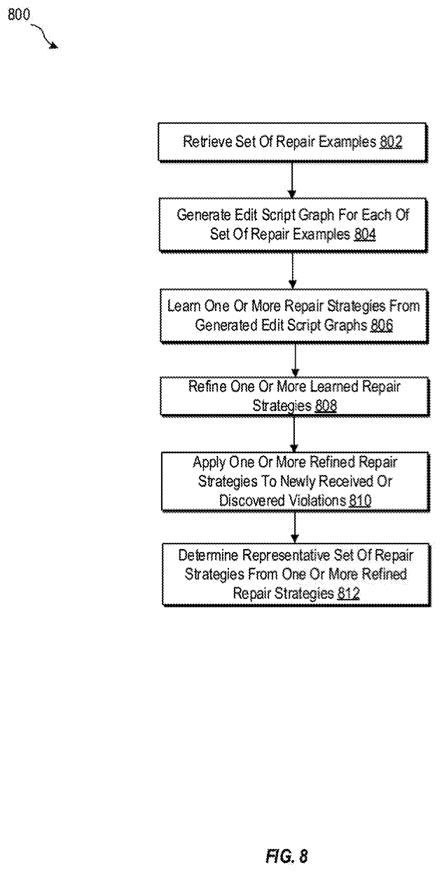

The electronic device 102 may be configured to identify at least one first string in the first repair example of the first software program and at least one second string in the second repair example of the second software program. The electronic device 102 may be configured to generate a first set of string edit actions for the first software program based on the identified at least one first string in the first repair example and the first violation. Similarly, the electronic device 102 may be configured to generate a second set of string edit actions for the second software program based on the identified at least one second string in the second repair example and the second violation. The first set of string edit actions and the second set of string edit actions are described in detail, for example, in FIGS. 6-7. Further, the electronic device 102 may be configured to determine one or more common string edit actions based on the generated first set of string edit actions and the generated second set of string edit actions. The determination of the one or more common string edit actions is described in detail, for example, in FIGS. 5A, 5B, 6, and 7. The electronic device 102 may be further configured to retrieve the third software program from the database 104. Alternatively, the electronic device 102 may receive the third software program from the user-end device 106. The electronic device 102 may be configured to apply the determined one or more common string edit actions on a string-related third violation of the third software program to generate a repaired third software program. The electronic device 102 may be configured to store the repaired third software program on the database 104 or alternatively send the repaired third software program to the user-end device 106. An example method for repair of string-related violations of software programs is explained in detail, for example, in FIG. 8.

Examples of the electronic device 102 may include, but are not limited to, an integrated development environment (IDE) device, a software testing device, a mobile device, a desktop computer, a laptop, a computer work-station, a computing device, a mainframe machine, a server, such as a cloud server, and a group of servers. In one or more embodiments, the electronic device 102 may include a user-end terminal device and a server communicatively coupled to the user-end terminal device. Examples of the user-end terminal device may include, but are not limited to, a mobile device, a desktop computer, a laptop, and a computer work-station. The electronic device 102 may be implemented using hardware including a processor, a microprocessor (e.g., to perform or control performance of one or more operations), a field-programmable gate array (FPGA), or an application-specific integrated circuit (ASIC). In some other instances, the electronic device 102 may be implemented using a combination of hardware and software.

The database 104 (for example, Big Code) may comprise suitable logic, interfaces, and/or code that may be configured to store the first set of violations 110A, the first set of repair examples 110B, the second set of violations 112A, and the second set of repair examples 112B. In some embodiments, the database 104 may store different software programs, code, libraries, applications, scripts, or routines associated with the first set of violations 110A, the first set of repair examples 110B, the second set of violations 112A, and the second set of repair examples 112B.

The database 104 may be a relational or a non-relational database. Also, in some cases, the database 104 may be stored on a server, such as a cloud server or may be cached and stored on the electronic device 102. The server of the database 104 may be configured to receive a request to provide data, violations, or programs from the electronic device 102, via the communication network 108. In response, the server of the database 104 may be configured to retrieve and provide the data, violations, or programs to the electronic device 102 based on the received request, via the communication network 108. Additionally, or alternatively, the database 104 may be implemented using hardware including a processor, a microprocessor (e.g., to perform or control performance of one or more operations), a field-programmable gate array (FPGA), or an application-specific integrated circuit (ASIC). In some other instances, the database 104 may be implemented using a combination of hardware and software.

The user-end device 106 may comprise suitable logic, circuitry, interfaces, and/or code in which the determined one or more common string edit actions may be stored or deployed for repair of a string-related violation of a software program. The user-end device 106 may include one or more of an integrated development environment (IDE), a code editor, a software debugger, software development kit, or a testing application which may recommend to the user 114 and/or apply the deployed one or more common string edit actions to repair different violations that may be identified in a software program during various software development stages, especially during code testing or verification and validation (V&V) stage. Examples of the user-end device 106 may include, but are not limited to, a mobile device, a desktop computer, a laptop, a computer work-station, a computing device, a mainframe machine, a server, such as a cloud server, and a group of servers. Although in FIG. 1, the user-end device 106 is separated from the electronic device 102; however, in some embodiments, the user-end device 106 may be integrated in the electronic device 102, without a deviation from the scope of the disclosure.

The communication network 108 may include a communication medium through which the electronic device 102 may communicate with the server which may store the database 104 and with the user-end device 106. Examples of the communication network 108 may include, but are not limited to, the Internet, a cloud network, a Wireless Fidelity (Wi-Fi) network, a Personal Area Network (PAN), a Local Area Network (LAN), and/or a Metropolitan Area Network (MAN). Various devices in the environment 100 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, and/or Bluetooth (BT) communication protocols, or a combination thereof.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the database 104 and the user-end device 106. In addition, in some embodiments, the functionality of each of the database 104 and the user-end device 106 may be incorporated into the electronic device 102, without a deviation from the scope of the disclosure.

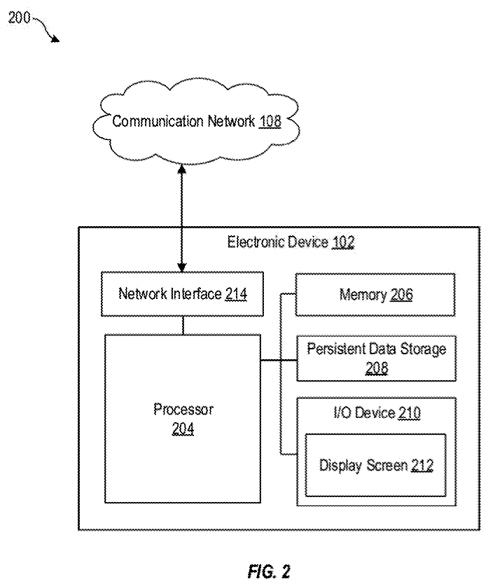

FIG. 2 is a block diagram that illustrates an exemplary electronic device for learning one or more string edit actions from repair examples of software programs, arranged in accordance with at least one embodiment described in the present disclosure. FIG. 2 is explained in conjunction with elements from FIG. 1. With reference to FIG. 2, there is shown a block diagram 200 of the electronic device 102. The electronic device 102 may include a processor 204, a memory 206, a persistent data storage 208, an input/output (I/O) device 210, a display screen 212, and a network interface 214.

The processor 204 may comprise suitable logic, circuitry, and/or interfaces that may be configured to execute program instructions associated with different operations to be executed by the electronic device 102. For example, some of the operations may include identification of the at least one first string in the first repair example and the at least one second string in the second repair example, generation of the first set of string edit actions and the second set of string edit actions, determination of the one or more common string edit actions, and application of the determined one or more common string edit actions on the string-related third violation of the third software program. The processor 204 may include any suitable special-purpose or general-purpose computer, computing entity, or processing device including various computer hardware or software modules and may be configured to execute instructions stored on any applicable computer-readable storage media. For example, the processor 204 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 2, the processor 204 may include any number of processors configured to, individually or collectively, perform or direct performance of any number of operations of the electronic device 102, as described in the present disclosure. Additionally, one or more of the processors may be present on one or more different electronic devices, such as different servers. In some embodiments, the processor 204 may be configured to interpret and/or execute program instructions and/or process data stored in the memory 206 and/or the persistent data storage 208. In some embodiments, the processor 204 may fetch program instructions from the persistent data storage 208 and load the program instructions in the memory 206. After the program instructions are loaded into the memory 206, the processor 204 may execute the program instructions. Some of the examples of the processor 204 may be a GPU, a CPU, a RISC processor, an ASIC processor, a CISC processor, a co-processor, and/or a combination thereof.

The memory 206 may comprise suitable logic, circuitry, interfaces, and/or code that may be configured to store program instructions executable by the processor 204. In certain embodiments, the memory 206 may be configured to store operating systems and associated application-specific information. The memory 206 may include computer-readable storage media for carrying or having computer-executable instructions or data structures stored thereon. Such computer-readable storage media may include any available media that may be accessed by a general-purpose or special-purpose computer, such as the processor 204. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204 to perform a certain operation or group of operations associated with the electronic device 102.

The persistent data storage 208 may comprise suitable logic, circuitry, interfaces, and/or code that may be configured to store program instructions executable by the processor 204, operating systems, and/or application-specific information, such as logs and application-specific databases. The persistent data storage 208 may include computer-readable storage media for carrying or having computer-executable instructions or data structures stored thereon. Such computer-readable storage media may include any available media that may be accessed by a general-purpose or a special-purpose computer, such as the processor 204.

By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204 to perform a certain operation or group of operations associated with the electronic device 102.

In some embodiments, either of the memory 206, the persistent data storage 208, or combination may store the first repair example, the first violation, the second repair example, and the second violation retrieved from the database 104. In some embodiments, either of the memory 206, the persistent data storage 208, or combination may store the first set of string edit actions, the second set of string edit actions, and the one or more common edit actions determined from the first repair example and the second repair example. In some embodiments, either of the memory 206, the persistent data storage 208, or combination may store the string-related third violation of the third software program and the repaired third software program.

The I/O device 210 may include suitable logic, circuitry, interfaces, and/or code that may be configured to receive a user input (for example, a user input to select a string-related third violation of the third software program). The I/O device 210 may be further configured to provide an output in response to the user input. The I/O device 210 may include various input and output devices, which may be configured to communicate with the processor 204 and other components, such as the network interface 214. Examples of the input devices may include, but are not limited to, a touch screen, a keyboard, a mouse, a joystick, and/or a microphone. Examples of the output devices may include, but are not limited to, a display and a speaker.

The display screen 212 may comprise suitable logic, circuitry, interfaces, and/or code that may be configured to render the determined one or more common edit actions and/or the repaired third software program. The display screen 212 may be configured to receive the user input from the user 114 to select the select the third software program with the string-related third violation to be repaired. In such cases the display screen 212 may be a touch screen to receive the user input. The display screen 212 may be realized through several known technologies such as, but not limited to, a Liquid Crystal Display (LCD) display, a Light Emitting Diode (LED) display, a plasma display, and/or an Organic LED (OLED) display technology, and/or other display technologies.

The network interface 214 may comprise suitable logic, circuitry, interfaces, and/or code that may be configured to establish a communication between the electronic device 102, the database 104, and the user-end device 106, via the communication network 108. The network interface 214 may be implemented by use of various known technologies to support wired or wireless communication of the electronic device 102 via the communication network 108. The network interface 214 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 214 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), or Wi-MAX.

Modifications, additions, or omissions may be made to the example electronic device 102 without departing from the scope of the present disclosure. For example, in some embodiments, the example electronic device 102 may include any number of other components that may not be explicitly illustrated or described for the sake of brevity.

FIG. 3 illustrates an exemplary repair example of a software program including a violation and a repaired software program, arranged in accordance with at least one embodiment described in the present disclosure. FIG. 3 is explained in conjunction with elements from FIG. 1 and FIG. 2. With reference to FIG. 3, there is shown examples of two versions of a software program 300 including an example of a defective software program 302 and an improved software program 304. The defective software program 302 may include a code, scripts, or routines associated with a domain specific language (DSL), for example, Java. The defective software program 302 may include one or more violations including a string-related violation (for example, “System.out.printf(“Error Code % d\n”, err)”, as shown in FIG. 3) at a node 302A, and a program-related violation (for example, “return null”, as shown in FIG. 3) at a node 302B. The one or more violations may indicate a fault or a bug which may affect the performance of the defective software program 302. Alternatively, or in addition, the one or more violations may indicate a naming convention error or stylistic violation in the defective software program 302. In some embodiments, the defective software program 302 may include a plurality of violations including the one or more violations at the nodes 302A and 302B. The one or more violations may be identified by the static code analysis tools known in the art.

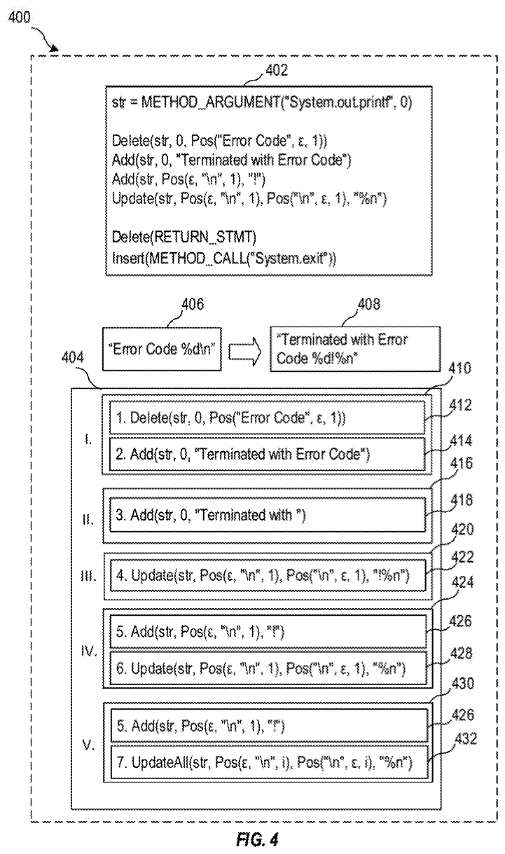

In FIG. 3, the improved software program 304 may be a repaired version (or a repair example) of the defective software program 302. The improved software program 304 may include one or more repair examples, including a string-related repair example (for example, “System.out.printf(“Terminated with Error Code % d!% n”, err)”, as shown in FIG. 3) at a node 304A, and a program-related repair example (for example, “System.exit(0)”, as shown in FIG. 3) at a node 304B. The defective software program 302 may be repaired based on one or more edit operations/actions performed on the defective software program 302 to obtain the improved software program 304. In general, an edit operation/action on a node associated with a violation may correspond to one or more of a replacement/exchange, appending code, a correction, a new addition, a deletion, a positional shift, or other modifications to a portion of code or string associated with the node. An example of a set of edit operations or actions that may be performed on a string-related violation to obtain a repaired software program for the string-related violation is explained, for example, in FIG. 4.

FIG. 4 illustrates exemplary edit operations/actions including string-related edit operations/actions to repair a defected software program based on an improved software program, arranged in accordance with at least one embodiment described in the present disclosure. FIG. 4 is explained in conjunction with elements from FIG. 1, FIG. 2, and FIG. 3. With reference to FIG. 4, there is shown an example of a first set of edit actions 402. The first set of edit actions 402 may correspond to one or more edit operations to repair the defective software program 302 to generated the improved software program 304 of FIG. 3. In an embodiment, the one or more edit operations/actions may include one or more string edit actions and one or more program edit actions. The one or more violations in the defective software program 302 may be detected using the static code analysis tool applied on the defective software program 302.

For example, as shown in FIG. 4, the first set of edit actions 402 may include a statement “str=METHOD ARGUMENT (“System.out.printf”, 0)” to assign a string associated with a first argument of the “System.out.printf( )” to a string variable ‘str’. A string portion (“Error Code % d\n”) associated with the defective software program 302 may be represented by the variable ‘str’. The contents of the variable ‘str’ may be updated by string edit actions to obtain string content (“Terminated with Error Code % d!% n”) in the improved software program 304. As shown in FIG. 4, the first set of edit actions 402 may further include string edit actions “Delete(str, 0, Pos(“Error Code”,ε, 1))” and “Add(str, 0, “Terminated with Error Code”)” to delete a first occurrence of the string “Error code” from the variable ‘str’ and add the string “Terminated with Error Code” to the variable ‘str’, respectively. The first set of edit actions 402 may further include a string edit action “Add(str, Pos(ε, “\n”, 1), “!”)” to add a character “!” at a position of the first occurrence of a special character “\n” in the variable ‘str’. Further, the first set of edit actions 402 may include a string edit action “Update(str, Pos(ε, “\n”, 1), Pos(“\n”,ε, 1), “% n”)” to update the first occurrence of the special character “\n” and any other character that follows the special character “\n” in the variable ‘str’ with “% n”. The function “Pos(string S1, string S2, number n1)” may output a position in a string (i.e. a series of characters) such that the position may be between the string S1 and a string S2 in the n-th occurrence of substring “S1S2”. For example, for a string “ABCABCABC”, the function “Pos(“C”, “A”, 2)” may return the position between 6th and 7th characters. Further, “c” may match either any character of the string, the beginning of the string, or the end of the string. In the same example, “Pos(ε, “A”, 1)” may return the beginning of the string, “Pos(“C”,ε, 1)” may return the position between 3rd and 4th characters, and “Pos(“C”,ε, 3)” may returns the end of the string.

To update program code differences between the defective software program 302 and the improved software program 304 and obtain the improved software program 304, certain program edit actions may be required. Therefore, the first set of edit actions 402 may include certain program edit actions, such as, “Delete(RETURN_STMT)” to delete the “return null” statement (at node 302B of FIG. 3) and “Insert(METHOD_CALL(“System.exit”))” to insert a method call to “System.exit( )” method (as shown at node 304B of FIG. 3).

In FIG. 4, there is also shown an example of a second set of edit actions 404 to convert a first string 406 (for example. “Error Code % d\ n”, as shown) in the string-related violation at the node 302A to a second string 408 (for example, “Terminated with Error Code % d!% n”, as shown) in the string-related repair example at the node 304A in FIG. 3. The second set of edit actions 404 may include one or more combinations of string edit action sequences to repair the string-related violation at the node 302A to get the string-related repair example at the node 304A. For example, a first combination of string edit actions 410 may include a first string edit action 412 (for example, “Delete(str, 0, Pos(“Error Code”,ε, 1))”, as shown) to delete the string “Error Code” from the first string 406. The first combination of string edit actions 410 may also include a second string edit action 414 (for example, “Add(str, 0, “Terminated with Error Code”)”, as shown) to add the string “Terminated with Error Code” at the start of the first string 406. In another example, a second combination of string edit actions 416 may include a third string edit action 418 (for example, “Add(str, 0, “Terminated with”)”, as shown) to prepend the string “Terminated with” to the first string 406 (including the string “Error Code”). The first combination of string edit actions 410 and the second combination of string edit actions 416 may be two different string edit action combinations to generate the string “Terminated with Error Code” in the second string 408 from the string “Error Code” in the first string 406.

In FIG. 4, there is further shown a third combination of string edit actions 420, a fourth combination of string edit actions 424, and a fifth combination of string edit actions 430, which may be three different string edit action combinations to replace the special character “\n” with the string “!% n” in the first string 406. In an embodiment, the processor 204 may be configured to execute any of the third combination of string edit actions 420, the fourth combination of string edit actions 424, or the fifth combination of string edit actions 430 to replace the special character “\n” with the string “!% n” in the first string 406. For example, the third combination of string edit actions 420 may include a fourth string edit action 422 (for example, “Update(str, Pos(ε, “\n”, 1), Pos(“\ n”,ε, 1), “!% n”)”, as shown) to replace the first occurrence of the special character “\n” and the characters that follow such special character with the string “!% n” in the first string 406.

In another example, the fourth combination of string edit actions 424 may include a fifth string edit action 426 (for example, “Add(str, Pos(ε, “\n”, 1), “!”)”, as shown) to add the character “!” at the position of the special character “\n” in the first string 406. Further, the fourth combination of string edit actions 424 may include a sixth string edit action 428 (for example, “Update(str, Pos(ε, “\n”, 1), Pos(“\n”,ε, 1), “% n”)”, as shown) to replace the first occurrence of the special character “\n” and the characters that follow such special character, with the string “% n” in the first string 406.

In another example, the fifth combination of string edit actions 430 may include the fifth edit action 426 (for example, “Add(str, Pos(ε, “\ n”, 1), “!”)”, as shown) to add the character “!” at the position of the special character “\n” in the string-related violation 4046. Further, the fifth combination of edit actions 430 may include a seventh edit action 432 (for example, “UpdateAll(str, Pos(ε, “\n”, i), Pos(“\n”,ε, i), “% n”)”, as shown) to replace an instance of the special character “\n” after its i^{th} instance and the characters that follow the i^{th} instance of such special character, with the string “% n” in the first string 406. In other words, UpdateAll( )edit action may be equivalent to repetition or iteration of the Update( )edit action for all possible values of “i”.

It may be noted that the first combination of string edit actions 410, the second combination of string edit actions 416, the third combination of string edit actions 420, the fourth combination of string edit actions 424, and the fifth combination of string edit actions 430 shown in FIG. 4 may correspond to a set of string edit action sequences. It may be noted here that the edit actions (including the one or more string edit actions and the one or more program edit actions) described in FIG. 4, are merely provided as an example. However, there may be several types of edit actions to repair the defective software program 302 based on the improved software program 304 of FIG. 3, without departing from the scope of the present disclosure.

FIG. 5A and FIG. 5B, collectively, illustrate an example of a graph associated with a set of string edit action sequences and illustrates an example of string edit action sequence to repair a string-related violation, respectively, arranged in accordance with at least one embodiment described in the present disclosure. FIGS. 5A and 5B are explained in conjunction with elements from FIG. 1, FIG. 2, FIG. 3, and FIG. 4. With reference to FIG. 5A, there is shown an example of a graph 500A associated with the set of string edit action sequences of FIG. 4.

The graph 500A is hereinafter referred as an edit script graph 500A. The edit script graph 500A may include a start node 502, followed by a set of nodes, each of which may represent a string edit action for the string-related violation 302A in the first string 406) to generate the second string 408 (including the string-related repair example 304A). The edit script graph may further include an end node 520. For example, as shown in FIG. 5A, the set of nodes may include a node-1 504, a node-2 506, a node-3 508, a node-4 512, a node-5 514, a node-6 516, and a node-7 518. The node-1 504 may represent the first edit action 412, the node-2 506 may represent the second edit action 414, and the node-3 508 may represent the third edit action 418. Further, the node-4 512 and node-5 514 may represent the fourth edit action 422 and the fifth edit action 426. The node-6 516 may represent the sixth edit action 428 and the node-7 518 may represent the seventh edit action 432. In certain embodiments, the edit script graph 500A may also include an intermediate node (e.g., a node 510) at which paths from two or more nodes may converge. In an embodiment, a path from the start node 502 to the end node 520 in the edit script graph 500A may represent a string edit action sequence (or path) that may repair the string-related violation 302A to obtain the string-related repair example 304A. An example of a string edit action sequence that may be obtained on traversal of a path of the edit script graph 500A is explained in detail, for example, in FIG. 5B.

With reference to FIG. 5B, there is shown an example of a string edit action sequence 500B to repair the string-related violation 302A based on the string-related repair example 302B. The string edit action sequence 500B may be performed, by the processor 204, by traversal of the path Node-1 504->Node-2 506->Node-5 514->Node-7 518 in the edit script graph 500A. The string edit action sequence 500B may include the first edit action 412 (for example, “Delete(str, 0, Pos(“Error Code”,ε, 1))”), the second edit action 414 (for example, “Add(str, 0, “Terminated with Error Code”)”), the fifth edit action 426 (for example, “Add(str, Pos(ε, “\n”, 1), “!”)”), and the seventh edit action 432 (for example, “UpdateAll(str, Pos(ε, “\n”, i), Pos(“\n”, c, i), “% n”)”), in the order shown in FIG. 5A.

It may be noted here that the edit script graph 500A and the string edit action sequence 500B described in FIGS. 5A and 5B, respectively, are merely provided as an example. However, there may be several types of edit script graphs and string edit action sequences to repair the string-related violation 302A based on or to generated the string-related repair example 304A of FIG. 3, without departure from the scope of the present disclosure.

FIG. 6 illustrates an example of a scenario of a learning one or more string edit actions from repair examples of software programs, arranged in accordance with at least one embodiment described in the present disclosure. FIG. 6 is explained in conjunction with elements from FIG. 1, FIG. 2, FIG. 3, FIG. 4, FIG. 5A, and FIG. 5B. With reference to FIG. 6, there is shown an exemplary scenario 600 for a learning one or more string edit actions from repair examples of software programs.

In FIG. 6, there is shown a first violation 602A and a first repair example 602B of a first software program, and a second violation 604A and a second repair example 604B of a second software program. In an embodiment, the first violation 602A (for example, “System.out.printf(“% s\n”, line1)”, as shown) and the second violation 604A (for example, “System.out.printf(“% s\n % s\n”, line1, line2)”, as shown) may be string-related violations of the first software program and the second software program, respectively. The first repair example 602B (for example, “System.out.printf(“% s % n”, line1)”, as shown) may be configured to repair the first violation 602A of the first software program. The second repair example 604B (for example, “System.out.printf(“% s % n % s % n”, line1, line2)”, as shown) may be configured to repair the second violation 604A of the second software program. For example, a first string “% s % n” in the first repair example 602B may be repaired string for a violated string “% s\n” in the first violation 602A. The processor 204 may consider the violated string in the first violation 602A as an input string and the first string in the first repair example 602B as the output string for further generation of a first set of string edit actions. In other words, the processor 204 may consider the input string and the output string as a string pair for different repair examples for the generation of the string edit actions, described further, for example, in FIG. 6.

In FIG. 6, there is further shown a first set of string edit actions 606 for the first software program to repair the first violation 602A and a second set of string edit actions 608 for the second software program to repair the second violation 604A. The first set of string edit actions 606 may include a first string edit action 610 (for e.g., “UpdateAll(str,Pos(ε,“\n”, 1),Pos(“\n”,ε, 1), “% n”)”) and a second string edit action 612 (for e.g., “UpdateAll(str,Pos(ε,“\n”,i),Pos(“\n”,ε,i),“% n”))”) that may be alternative edit actions to repair the first violation 602A. The second set of string edit actions 608 may include the second string edit action 612, a third string edit action 616 (for e.g., “Update(str,Pos(ε,“\n”, 1),Pos(“\n”,ε, 1),“% n”)”), and a fourth string edit action 618 (for e.g., “Update(str,Pos(ε,“\n”, 2),Pos(“\n”,ε, 2),“% n”)”). The third string edit action 616 and the fourth string edit action 618, which may be collectively referred as a group of string edit actions 614, may be alternative edit actions to the second string edit action 612 to repair the second violation 604A. FIG. 6 also shows a common string edit action between the first set of string edit actions 606 and the second set of string edit actions 608, as the second string edit action 612 (i.e., “UpdateAll(str,Pos(ε,“\ n”,i),Pos(“\n”,ε,i),“% n”))”) as shown in FIG. 6.

In an embodiment, the processor 204 of the electronic device 102 may be configured to identify at least one first string in the first repair example 602B of the first software program and at least one second string in the second repair example 604B of the second software program. For example, the processor 204 may identify “% s % n” as the at least one first string from the first repair example 602B and “% s % n % s % n” as the at least one second string from the second repair example 604B. The processor 204 may be configured to generate the first set of string edit actions 606 for the first software program based on the identified at least one first string (i.e., “% s % n”) in the first repair example 602B and the first violation 602A. For example, the processor 204 may generate one or more alternative edit actions (e.g., the first string edit action 610 and the second string edit action 612 as the first set of string edit actions 606), where each may convert a string (e.g., “% s\ n”, i.e. input string) in the first violation 602A to the at least one first string (i.e., “% s % n”, i.e output string), as in the first repair example 602B. Similarly, the processor 204 may be configured to generate the second set of string edit actions 608 for the second software program based on the identified at least one second string (i.e., “% s % n % s % n”) in the second repair example 604B and string-related violation in the second violation 604A. In FIG. 6, the string “% s\n % s\n” in the second violation 604A may correspond to the input string and the second string “% s % n % s % n” in the second repair example 604B may correspond to the output string by the disclosed electronic device 102 for the generation of the second set of string edit actions 608.

In an embodiment, the processor 204 may be further configured to determine the one or more common string edit actions based on the generated first set of string edit actions 606 and the generated second set of string edit actions 608. For example, the processor 204 may determine the second string edit action 612 (for e.g., “UpdateAll(str,Pos(ε,“\n”,i),Pos(“\n”,ε,i),“% n”))”) as the one or more common string edit actions from the first set of string edit actions 606 and the second set of string edit actions 608. In other words, the processor 204 may determine that the second string edit action 612 may be the common string edit action (i.e. generalized string edit action) which may be used or capable to repair both the first violation 602A and the second violation 604A in the first software program and the second software program, respectively. In an embodiment, the processor 204 may be further configured to store the determined one or more common string edit actions in a database, such as, the database 104, the memory 206, the persistent data storage 208, or a combination thereof.

In an embodiment, the processor 204 may be further configured to apply the determined one or more common string edit actions on a string-related third violation of a third software program to generate a repaired third software program. For example, the string-related third violation of the third software program may be “System.out.printf(“% s\n % s\n % s\n”, line1, line2, line3)“. The processor 204 may apply the one or more common string edit actions, such as, the second string edit action 612 (for example, “UpdateAll(str,Pos(ε,“\n”,i),Pos(“\n”,ε,i),“% n”))”), on the third string-related violation of the third software program to generate the repaired third software program. The repaired third software program generated from the second string edit action 612 may be, for example, “System.out.printf(“% s % n % s % n % s % n, line1, line2, line3)”.

The one or more common string edit actions, determined based on the generated first set of string edit actions 606 and the generated second set of string edit actions 608, may correspond to the string edit actions learnt from the first repair example 602B of the first software program and the second repair example 604B of the second software program. Thus, the learnt common string edit actions may be the generalized string edit actions which may repair different unsolved or newly discovered violations in different software programs. The processor 204 may learn a plurality of such one or more common string edit actions from different repair examples of software programs to repair string-related violations in new software programs. Hence, the disclosed electronic device 102 may perform the fine-grained analysis by analyzing the differences between the strings present in the violations and the corresponding repair examples of different software programs, further generating different set of string edit actions based on the analysis of the differences, and further learning the common string edit actions from the generated set of string edit actions associated with different repair examples of same or different software programs.

It may be noted here that the first set of string edit actions 606 and the second set of string edit actions 608 are merely provided as an example. However, there may be several types of string edit actions to repair string-related violations based on a string-related repair example, without departing from the scope of the present disclosure.

FIG. 7 illustrates an example of a scenario of learning one or more string edit actions from edit script graphs of software programs, arranged in accordance with at least one embodiment described in the present disclosure. FIG. 7 is explained in conjunction with elements from FIG. 1, FIG. 2, FIG. 3, FIG. 4, FIG. 5A, FIG. 5B, and FIG. 6. With reference to FIG. 7, there is shown an exemplary scenario 700 for learning one or more string edit actions from edit script graphs of software programs.

In FIG. 7, there is shown a first edit script graph 702, a second edit script graph 704, and a third edit script graph 706. The first edit script graph 702 may include a start node 702A, a first node 708, a second node 710, and an end node 702B. The second edit script graph 704 may include a start node 704A, the second node 710, a third node 712, and a fourth node 714. The third edit script graph 706 may include a start node 706A, the second node 710, and the end node 706B. In an embodiment, the first edit script graph 702 may represent the first set of string edit actions 606 (including the first string edit action 610 of FIG. 6 as the first node 708, and the second string edit action 612 of FIG. 6 as the second node 710) to repair the first violation 602A based on the first repair example 602B. The second edit script graph 704 may represent the second set of string edit actions 608 (including the second string edit action 612 of FIG. 6 as the second node 710, the third string edit action 616 of FIG. 6 as the third node 712, and the fourth string edit action 618 of FIG. 6 as the fourth node 714) to repair the second violation 604A based on the second repair example 604B or to generate the second repair example 604B. The third edit script graph 706 may represent the one or more common string edit actions (such as, the second string edit action 612 shown in FIG. 6) determined from the first set of string edit actions 606 and the second set of string edit actions 608.

In an embodiment, the processor 204 may be configured to generate a node for each of the generated first set of string edit actions 606 for the identified at least one first string (e.g., “% s % n”) in the first repair example 602B of the first software program. For example, the processor 204 may generate the first node 708 for the first string edit action 610 and the second node 710 for the second string edit action 612. In other words, the processor 204 may generate the first string edit action 610 as the first node and generate the second string edit action 612 as the second node 710. The processor 204 may be further configured to generate a first graph (such as, the first edit script graph 702) based on associations or connections between generated nodes for the generated first set of string edit actions 606. For example, the first string edit action 610 and the second string edit action 612 may be independent of one another and may be alternative string edit actions that may be used to repair the first violation 602A. In such case, the processor 204 may generate the first edit script graph 702 to include the first node 708 and the second node 710, which may not be connected with one another. Each of the first node 708 and the second node 710 may be connected to the start node 702A and the end node 702B, as separate paths, as shown in FIG. 7.

Similarly, the processor 204 may be configured to generate a node for each of the generated second set of string edit actions 608 for the identified at least one second string (e.g., “% s % n % s % n”) in the second repair example 604B of the second software program. For example, the processor 204 may generate the second node 710 for the second string edit action 612, the third node 712 for the third string edit action 616, and the fourth node 714 for the fourth string edit action 618. In other words, the processor 204 may generate the second string edit action 612 as the second node 710, generate the third string edit action 616 as the third node 712 and generate the fourth string edit action 618 as the fourth node 714. The processor 204 may be further configured to generate a second graph (such as, the second edit script graph 704) based on associations or connections between generated nodes for the generated second set of string edit actions 608. For example, the second string edit action 612 may be an alternative edit action to the group of string edit actions 614 (that may include the third string edit action 616 followed by the fourth string edit action 618, in that order). In such case, the processor 204 may generate the second edit script graph 704 with the second node 710 directly connected to the start node 704A and the end node 704B. The processor 204 may further include the third node 712 and the fourth node 714, in that order, in the second edit script graph 704 between the start node 704A and the end node 704B. The third node 712 and the fourth node 714 may be a parallel path to the second node 710 in the second edit script graph 704, as shown in FIG. 7.

In an embodiment, the processor 204 may be configured to determine one or more common nodes based on the generated first graph (e.g., the first edit script graph 702) and the second graph (e.g., the second edit script graph 704). For example, the processor 204 may determine the second node 710 as the one or more common nodes between the first edit script graph 702 and the second edit script graph 704. To determine the one or more common nodes (e.g., the second node 710), the processor 204 may perform an intersection operation (i.e. operation 716 shown in FIG. 7) on the first edit script graph 702 and the second edit script graph 704. Based on the intersection operation, the processor 204 may identify the nodes or string edit actions which may be commonly present in multiple edit script graphs or multiple sets of string edit actions corresponding to different repair examples in the same or different software programs. In an embodiment, the processor 204 may generate the third edit script graph 706 by including the determined one or more common nodes (i.e., the second node 710), in its associated order, to the third edit script graph 706 between the start node 706A and the end node 706B. In an embodiment, the determined one or more common nodes (e.g., the second node 710) may correspond to a common path present in the first edit script graph 702 and the second edit script graph 704. The one or more common nodes (e.g., the second node 710) may represent a common set of string edit actions that may be learnt from the first software program and the second software program to repair string-related violations of a certain type from new software programs. For example, the determined one or more common string edit actions may include the second string edit action 612, such as, “UpdateAll(str,Pos(ε,“\n”,i),Pos(“\n”,ε,i),“% n”))”, as shown in FIG. 7. The learnt common nodes or the string edit actions may be more accurate to repair new unrepaired string-related violations or string-related violations in new software program because the common nodes or the string edit actions may be determined by the disclosed electronic device 102 from the already repaired examples and the violations of multiple software programs already stored as repaired in the database 104.

It may be noted here that the first edit script graph 702, the second edit script graph 704, and the third edit script graph 706 are merely provided as examples. However, there may be several types of edit script graphs that may represent string edit actions to repair a string-related violation based on a string-related repair example, without departing from the scope of the present disclosure.

FIG. 8 is a flowchart of an example method for repair of string-related violations of software programs, arranged in accordance with at least one embodiment described in the present disclosure. FIG. 8 is explained in conjunction with elements from FIG. 1, FIG. 2, FIG. 3, FIG. 4, FIG. 5A, FIG. 5B, FIG. 6, and FIG. 7. With reference to FIG. 8, there is shown a flowchart 800. The method illustrated in the flowchart 800 may start at 802 and may be performed by any suitable system, apparatus, or device, such as by the example electronic device 102 of FIG. 1 or FIG. 2. Although illustrated with discrete blocks, the steps and operations associated with one or more of the blocks of the flowchart 800 may be divided into additional blocks, combined into fewer blocks, or eliminated, depending on the particular implementation.

At block 802, a set of repair examples may be retrieved. In an embodiment, the processor 204 may be configured to retrieve the set of repair examples (such as the first set of repair examples 110B in FIG. 1) of a set of software programs from a repository (such as the database 104). The processor 204 may also retrieve a set of violations (such as the first set of violations 110A in FIG. 1) corresponding to each of the set of repair examples. Each of the set of violations may be a string-related violation. In an embodiment, the repository may be a Big-Code repository that may store a plurality of repair examples and a plurality of violations of each of a plurality of software programs. The repository may include the database 104, the memory 206, the persistent data storage 208, or a combination thereof.

At block 804, an edit script graph may be generated for each of the set of repair examples. In an embodiment, the processor 204 may be configured to generate the edit script graph for each of the set of repair examples based on corresponding string-related violation from the set of violations, thereby generating a set of edit script graphs for the set of repair examples.

For example, the processor 204 may identify a first string in a first repair example of a first software program. The first repair example may be configured to repair a first violation of the first software program. The processor 204 may be further configured to generate a first set of string edit actions for the first software program based on the identified first string in the first repair example and corresponding violated string in the first violation. In other words, the identified first string in the first repair example may correspond to an output string and the string-related violation in the first violation may correspond to an input string for the generation of the first set of string edit actions, as described, for example, in FIG. 6. The processor 204 may be configured to generate a node for each of the generated first set of string edit actions for the identified first string in the first repair example of the first software program. Further, the processor 204 may be configured to generate a first graph (as a first edit script graph for the first repair example) based on associations or connections between generated nodes for the generated first set of string edit actions, as explained in detail, for example, FIG. 6 and FIG. 7.

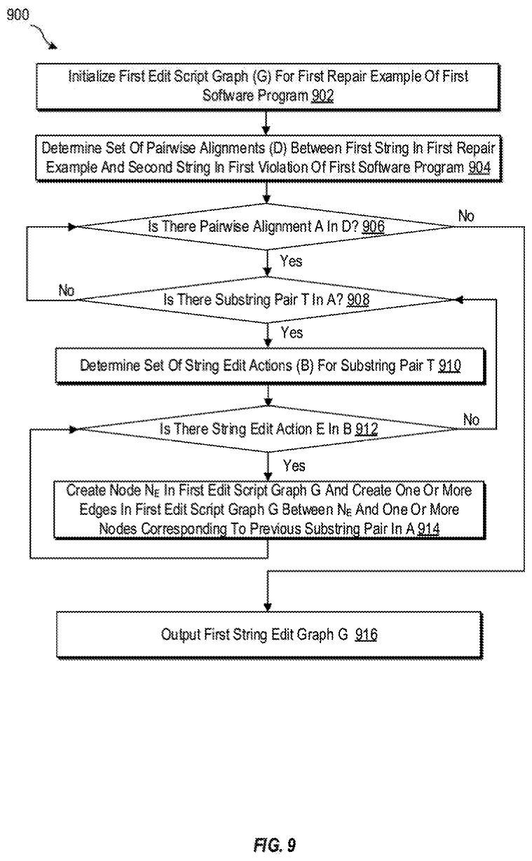

In case of existence of multiple strings in the first repair example or multiple string-related violations associated with the first repair example, the processor 204 may similarly identify a first plurality of strings in the first repair example. For the first plurality of strings, the processor 204 may generate multiple graphs such that there is one graph representative of set of string edit actions for each string. The processor 204 may be configured to generate a plurality of such graphs based on each of the identified first plurality of strings. The generation of an edit script graph for a string identified in a repair example and related violation is explained in detail, for example, in FIG. 9.

At block 806, one or more repair strategies may be learned from the generated edit script graphs. In an embodiment, the processor 204 may be configured to learn the one or more repair strategies for the set of violations based on the edit script graphs generated for the set of repair examples corresponding to the set of violations. For example, with reference to FIGS. 6 and 7, the processor 204 may generate a first graph (e.g., the first edit script graph 702) for the first repair example 602B associated with the first violation 602A and a second graph (e.g., the second edit script graph 704) for the second repair example 604B associated with the second violation 604A. The first edit script graph 702 may represent the first set of string edit actions 606 to repair the first violation 602A based on the first repair example 602B. Similarly, the second edit script graph 704 may represent the second set of string edit actions 608 to repair the second violation 604A based on the second repair example 604B. The processor 204 may be configured to determine the one or more common string edit actions from the first set of string edit actions 606 and the second set of string edit actions 608, based on the intersection operation (i.e. operation 716 shown in FIG. 7) performed on the first edit script graph 702 and the second edit script graph 704. The one or more common string edit actions (e.g., the second string edit action 612) may correspond to a repair strategy learned by the processor 204 to repair different string-related violations (for example newly discovered string violations) similar to the first violation 602A and the second violation 604A. The processor 204 may represent the learnt repair strategy as the third edit script graph 706. Similarly, the processor 204 may learn the one or more repair strategies for different string related violations in the set of violations for various software programs.

In case of existence of multiple strings in the first repair example 602B, the processor 204 may identify a first plurality of strings in the first repair example 602B. Similarly, in case there exists multiple strings in the second repair example 604B, the processor 204 may identify a second plurality of strings in the second repair example 604B. The processor 204 may be configured to generate a set of string edit actions (e.g., the first set of string edit actions 606) for each of the identified first plurality of strings. Further, the processor 204 may generate another set of string edit actions (e.g., the second set of string edit actions 608) for each of the identified second plurality of strings in the second repair example 604B of the second software program. The processor 204 may determine the one or more common string edit actions (e.g., the second string edit action 612) based on the generated two sets of string edit actions (e.g., the first set of string edit actions 606 and the second set of string edit actions 608). As already explained above, the determined one or more common set of string edit actions may correspond to one or more learned repair strategies.

In some embodiments, the processor 204 may use the set of repair examples to automatically learn and generate repair strategies (or common repair patterns) through different learning techniques (for example, machine learning), such as, “programming by example (PbE)” based repair pattern learning or generation systems. For example, FLA18-007 U.S. patent application Ser. No. 16/109,434 filed on Aug. 22, 2018, which is incorporated by reference herein in its entirety, discusses the generation and learning of repair patterns based on different violations in one or more software programs and based on repair examples associated with the violation. It may be noted that methods to generate the repair pattern by the referenced application are merely an example. Although, there may be different other ways to generate or learn the repair patterns based on different repair examples or edit operations/actions performed to repair of the violations, without departure from the scope of the disclosure.

At block 808, the one or more learned repair strategies may be refined. In an embodiment, the processor 204 may be configured to refine the one or more learned repair strategies. In some embodiments, the processor 204 may select a set of unfixed violations that may not have an associated repair example. The processor 204 may select an unfixed violation from the set of unfixed violations and apply a repair strategy from the one or more repair strategies on the selected unfixed violation to determine whether the repair strategy repairs the selected unfixed violation or not. If the selected unfixed violation is not repaired by the applied repair strategy, the processor 204 may purge the applied repair strategy from the one or more repair strategies. The processor 204 may iterate the operation of the selection of a repair strategy from the one or more repair strategies and the purging of the selected repair strategy from the one or more repair strategies to obtain the refined one or more repair strategies that may repair the selected unfixed violation. In certain embodiments, the processor 204 may be further configured to receive an input from the user 114 (e.g., an experienced software developer) to refine the one or more repair strategies. The input from the user 114 may indicate a selection of one or more repair examples (i.e., repair patterns or repair strategies) for addition to the one or more repair strategies to determine the refined repair strategies. Thus, the refinement of the set of repair strategies may be further based on an intervention or feedback received from the user 114.

For example, U.S. patent application Ser. No. 16/447,535 (Atty Docket No. FPC.19-00040.0RD) filed on Jun. 20, 2019, which is incorporated by reference herein in its entirety, discusses the refinement of the one or more repair strategies in detail. It may be noted that methods to refine the one or more repair strategies by the referenced application are merely an example. Although, there may be different other ways to refine the one or more repair strategies, without departure from the scope of the disclosure.

At block 810, the refined set of repair strategies may be applied on newly received or discovered violations. In some embodiments, the processor 204 may be configured to retrieve or receive newly discovered violations from the database 104. The newly discovered violations may be included in a third software program (i.e. different from the software programs based on which one or more common string edit actions may be determined). The processor 204 may be further configured to apply the refined set of repair strategies (as refined at block 808) on the newly received violations to repair the newly discovered violations or to further test whether the refined set of repair strategies can be used to repair the newly discovered violations in the database 104 or not. In case of repair, the application of the refined set of repair strategies on the newly received violations may generate a repaired third software program. Thus, based on the refinement of the set of repair strategies due to one or a combination thereof of: unfixed violations, human feedback, or newly discovered violations, the accuracy or quality of the learned set of repair strategies to repair unfixed violations may be increased.

At block 812, a representative set of repair examples may be determined from the one or more refined repair strategies. In an embodiment, the processor 204 may be configured to determine the representative set of repair examples from the one or more refined repair strategies. In some embodiments, the processor 204 may identify a violation in a software program and identify a patch (or a repair example or a repair strategy) from the database 104 to repair the violation. Further, the processor 204 may identify a second software program that may have a violation of the same or similar type and may be repaired by the identified repair example. The processor 204 may simplify the identified second software program by removal of one or more elements from a portion of the identified second software program as extraneous. The processor 204 may determine the simplified second software program as an example of the patch or a representative repair example. Similarly, the processor 204 may determine each of the representative set of repair examples from the one or more repair strategies.

For example, U.S. patent application Ser. No. 16/597,646 (Atty Docket No. FPC.19-00915.ORD) filed on Oct. 9, 2019, which is incorporated by reference herein in its entirety, discusses the determination of the representative set of repair examples in detail. It may be noted that methods to determine the representative set of repair examples by the referenced application are merely an example. Although, there may be different other ways to determine the representative set of repair examples, without departure from the scope of the disclosure.

Although the flowchart 800 is illustrated as discrete operations, such as 802, 804, 806, 808, 810, and 812. However, in certain embodiments, such discrete operations may be further divided into additional operations, combined into fewer operations, or eliminated, depending on the particular implementation without detracting from the essence of the disclosed embodiments.

FIG. 9 is a flowchart of an example method for generation of an edit script graph based on a repair example for a string-related violation of a software program, arranged in accordance with at least one embodiment described in the present disclosure. FIG. 9 is explained in conjunction with elements from FIG. 1, FIG. 2, FIG. 3, FIG. 4, FIG. 5A, FIG. 5B, FIG. 6, FIG. 7, and FIG. 8. With reference to FIG. 9, there is shown a flowchart 900. The method illustrated in the flowchart 900 may start at 902 and may be performed by any suitable system, apparatus, or device, such as by the example electronic device 102 of FIG. 1 or FIG. 2. Although illustrated with discrete blocks, the steps and operations associated with one or more of the blocks of the flowchart 900 may be divided into additional blocks, combined into fewer blocks, or eliminated, depending on the particular implementation.

At block 902, a first edit script graph for a first repair example of a first software program may be initialized. In an embodiment, the processor 204 may be configured to initialize the first edit script graph (that may be represented as a graph “G”) for the first repair example, as an empty graph. The processor 204 may then include a start node in the empty first edit script graph “G”. The first repair example may correspond to a first violation of the first software program and may be configured to repair the first violation. Further, the first violation may be a string-related violation of the first software program as described, for example, in FIGS. 3 and 6.

At block 904, a set of pairwise alignments between a first string in the first repair example and a second string in the first violation of the first program may be determined. In an embodiment, the processor 204 may be configured to determine the set of pairwise alignments. In an embodiment, the determined set of pairwise alignments may correspond to a set of alignments feasible for the first string and the second string. For example, as described in FIG. 6, the first string in the first repair example may include string “% s % n” in the first repair example 602B (i.e. output string) and the second string in the first violation may include string “% s \n” in the first violation 602A (i.e. input string). The set of pairwise alignments may be represented as a set “D”. In some embodiments, the processor 204 may determine a pairwise alignment between at least one first string (e.g., the first string) in the first repair example and the first violation (including, for example, the second string) of the first software program.

For example, to determine each of the set of pairwise alignments between the first string and the second string, the processor 204 may use an inexact matching technique, including but not limited to, a global alignment technique, a local alignment technique, an ends free-space alignment technique, or a gap penalty-based alignment technique. In an embodiment, the processor 204 may perform the inexact matching technique based on, but not limited to, a dynamic programming model, a Hidden Markov Model (HMM), a progressive method-based model, a genetic model, or a simulated annealing model.

For example, the first string in the first repair example is “Terminated with Error Code % d!% n” and the second string in the first violation is “Error Code % d\n”. An example of a set of pairwise alignments for the first string and the second string is as follows in Table 2:

TABLE 2
Example of a set of pairwise alignments of the first string and the second string

| First String | Second String | Alignments |
|---|---|---|
| “Terminated with | “Error Code | First Alignments: |
| Error Code %d!%n” | %d\n” | “Error Code” aligned with “Terminated with |
| | | Error Code” |
| | | “%d” aligned with “%d” |
| | | “\n” aligned with “!%n” |
| | | Second Alignments: |
| | | No sub-string of second string aligned with |
| | | the sub-string “Terminated with” of first string |
| | | “Error Code” aligned with “Error Code” |
| | | “%d” aligned with “%d” |
| | | “\n” aligned with “!%n” |
| | | “Error Code” aligned with “Terminated with |
| | | Error Code” |
| | | “%d” aligned with “%d” |
| | | No sub-string of first string aligned with the |
| | | sub-string “!” of first string |
| | | “\n” aligned with “%n” |

For example, with reference to Table 2, the first alignments of the set of pair wise alignments between the first string and the second string may include the sub-string “Error Code” of the second string aligned with the sub-string “Terminated with Error Code” of the first string. Similarly, as shown in Table 2, the sub-string “% d” of the second string may be aligned with the sub-string “% d” of the first string. Further, the sub-string “\n” of the second string may be aligned with the sub-string “!% n” of the first string. The explanation of other example alignments (e.g., the second alignments and the third alignments) between the sub-strings of the first string and second string, shown in Table 2, is omitted for the sake of brevity. It should be noted that data provided in Table 2 may merely be taken as example data and may not be construed as limiting the present disclosure.

At block 906, a check may be performed to determine whether there exists a previously unselected pairwise alignment in the set of pairwise alignments. In an embodiment, the processor 204 may be configured to perform the check. In other words, the block 906 may be performed to check whether each pairwise alignment from the set of pairwise alignments has been processed or not. In case, the set of pairwise alignments “D” includes a previously unselected pairwise alignment “A”, the processor 204 may be configured to select the pairwise alignment “A” from the set of pairwise alignments “D” as a next pairwise alignment. Control may then pass to block 908 for the next pairwise alignment “A”. Otherwise, if each of the pairwise alignments in the set of pairwise alignments “D” has been previously selected and processed, control may pass to block 916.

At block 908, a check may be performed to determine whether there exists a previously unselected sub-string pair from a set of sub-string pairs in the currently selected pairwise alignment. In an embodiment, the processor 204 may be configured to perform the check. In other words, the block 908 may be performed to check whether each sub-string pair from the set of sub-string pairs in the currently selected pairwise alignment has been processed. In case the currently selected pairwise alignments “A” includes a previously unselected sub-string pair “T”, the processor 204 may be configured to select the sub-string pair “T” from currently selected pairwise alignment “A” as a next sub-string pair. Control may then pass to block 910 for the next sub-string pair “T”. Otherwise, if each of the sub-string pairs in the currently selected pairwise alignment “A” has been previously selected, control may pass to block 906.

For example, with reference to Table 2, for the first pairwise alignments, the processor 204 may be configured to determine the set of sub-string pairs as a first sub-string pair of sub-strings “Error Code” and “Terminated with Error Code”, a second sub-string pair of sub-strings” % d” and “% d”, and a third sub-string pair of sub-strings “\n” and “!% n”. The processor 204 may select the first sub-string pair as the next sub-string pair “T”.

At block 910, a set of string edit actions may be determined for the currently selected sub-string pair. In an embodiment, the processor 204 may be configured to determine the set of string edit actions from the currently selected sub-string pair “T”. In an embodiment, the determined set of string edit actions may correspond to a set of string edit actions feasible for two sub-strings in the sub-string pair “T”. The first set of string edit actions may be represented as a set “B”. In an embodiment, the processor 204 may be configured to generate the set of string edit actions for the first software program based on the determined pairwise alignment. In an embodiment, the processor 204 may use one or more string differencing techniques to generate the set of string edit actions.

For example, with reference to Table 2, for the first pairwise alignments, the processor 204 may select a sub-string “Terminated with Error Code” from the first string in the first repair example, and a sub-string “Error Code” from the second string in the first violation, as the selected sub-string pair “T” (e.g., the first sub-string pair). Further, the processor 204 may determine the set of string edit actions to convert the sub-string “Error Code” (corresponding to the string violation) to the sub-string “Terminated with Error Code” (corresponding to the repair example), as:

1. “Delete (str, 0, Pos(“Error Code”,ε, 1); and
2. “Add (str, 0, “Terminated with Error Code”)”.

In an example, “str” may correspond to a string variable initialized with the value of the sub-string “Error Code” from the second string. The first string edit action (i.e., “Delete (str, 0, Pos(“Error Code”,ε, 1)” shown above may delete the string “Error Code” from the sub-string “Error Code” of the second string. Further, the second string edit action (i.e., “Add (str, 0, “Terminated with Error Code”)” shown above may add the string “Terminated with Error Code” in the empty sub-string of the second string.

At block 912, a check may be performed to determine whether there exists a previously unselected string edit action from the set of string edit actions determined for the currently selected sub-string pair. In an embodiment, the processor 204 may be configured to perform the check. In other words, the block 912 may be performed to check whether each string edit action “E” from the set of string edit actions “B” for the currently selected sub-string pair “T” has been processed or not. In case, the set of string edit actions “B” for the currently selected sub-string pair “T” includes a previously unselected string edit action “E”, the processor 204 may be configured to select the string edit action pair “E” from the set of string edit actions “B” as a next string edit action. Control may then pass to block 914 for the next string edit action “E”. Otherwise, if each of the string edit actions the set of string edit actions “B” for the currently selected sub-string pair “T” has been previously selected and processed, control may pass to block 908.

At block 914, a node and one or more associated edges may be created in the first edit script graph for the selected string edit action. In an embodiment, the processor 204 may be configured to create a node “NE” in the first edit script graph “G” for the selected string edit action “E”. Further, the processor 204 may be configured to create one or more edges in the first edit script graph “G” between the created node “NE” and one or more nodes that correspond to the previous sub-string pair in the pairwise alignment “A” The creation of the edit script graph is described, for example, in FIGS. 5A and 7. Control may pass to block 912.

At block 916, the first edit script graph may be obtained. In an embodiment, the processor 204 may be configured to obtain the first edit script graph “G”. The processor 204 may store the obtained first edit script graph “G” in the database 104, the memory 206, the persistent data storage 208, or a combination thereof. An example of the first edit script graph “G” is explained in detail, for example, in FIG. 5A. Control may pass to end.

Although the flowchart 900 is illustrated as discrete operations, such as 902, 904, 906, 908, 910, 912, 914 and 916. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause a system (such as the example electronic device 102) to perform operations. The operations may include identifying at least one first string in a first repair example and at least one second string in a second repair example. The first repair example may be configured to repair a first violation of a first software program, and the second repair example may be configured to repair a second violation of a second software program. The first violation and the second violation may be string-related violations. The operations may further include generating a first set of string edit actions for the first software program based on the identified at least one first string in the first repair example and the first violation. The operations may further include generating a second set of string edit actions for the second software program based on the identified at least one second string in the second repair example and the second violation. The operations may further include determining one or more common string edit actions based on the generated first set of string edit actions and the generated second set of string edit actions. The operations may further include applying the determined one or more common string edit actions on a string-related third violation of a third software program to generate a repaired third software program.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
identifying at least one first string in a first repair example and at least one second string in a second repair example, wherein the first repair example is configured to repair a first violation of a first software program, and the second repair example is configured to repair a second violation of a second software program, and wherein the first violation and the second violation are string-related violations;
generating a first set of string edit actions for the first software program based on the identified at least one first string in the first repair example and the first violation;
generating a second set of string edit actions for the second software program based on the identified at least one second string in the second repair example and the second violation;
determining one or more common string edit actions based on the generated first set of string edit actions and the generated second set of string edit actions; and
applying the determined one or more common string edit actions on a string-related third violation of a third software program to generate a repaired third software program.

2. The method according to claim 1, further comprising storing the determined one or more common string edit actions in a database.

3. The method according to claim 1, further comprising:
identifying a first plurality of strings in the first repair example of the first software program;
identifying a second plurality of strings in the second repair example of the second software program;
generating the first set of string edit actions for each of the identified first plurality of strings;
generating the second set of string edit actions for each of the identified second plurality of strings; and
determining the one or more common string edit actions based on the generated first set of string edit actions and the generated second set of string edit actions.

4. The method according to claim 1, further comprising:
generating a node for each of the generated first set of string edit actions for the identified at least one first string in the first repair example of the first software program;
generating a first graph based on associations between the generated nodes for the generated first set of string edit actions;
generating a node for each of the generated second set of string edit actions for the identified at least one second string in the second repair example of the second software program; and
generating a second graph based on associations between the generated nodes for the generated second set of string edit actions.

5. The method according to claim 1, further comprising:
identifying a first plurality of strings in the first repair example of the first software program; and
generating a plurality of graphs based on each of the identified first plurality of strings.

6. The method according to claim 4, further comprising determining one or more common nodes based on the generated first graph and the second graph, wherein the determined one or more common nodes correspond to the determined one or more common string edit actions.

7. The method according to claim 1, further comprising:
determining a pairwise alignment associated with the at least one first string in the first repair example and the first violation of the first software program; and
generating the first set of string edit actions based on the determined pairwise alignment.

8. The method according to claim 1, wherein the first repair example includes the at least one first string and at least one first program code of the first software program.

9. One or more non-transitory computer-readable storage media configured to store instructions that, in response to being executed, cause a system to perform operations, the operations comprising:
identifying at least one first string in a first repair example and at least one second string in a second repair example, wherein the first repair example is configured to repair a first violation of a first software program, and the second repair example is configured to repair a second violation of a second software program, and wherein the first violation and the second violation are string-related violations;
generating a first set of string edit actions for the first software program based on the identified at least one first string in the first repair example and the first violation;
generating a second set of string edit actions for the second software program based on the identified at least one second string in the second repair example and the second violation;
determining one or more common string edit actions based on the generated first set of string edit actions and the generated second set of string edit actions; and
applying the determined one or more common string edit actions on a string-related third violation of a third software program to generate a repaired third software program.

10. The one or more computer-readable storage media according to claim 9, wherein the operations further comprising:
identifying a first plurality of strings in the first repair example of the first software program;
identifying a second plurality of strings in the second repair example of the second software program;
generating the first set of string edit actions for each of the identified first plurality of strings;
generating the second set of string edit actions for each of the identified second plurality of strings; and
determining the one or more common string edit actions based on the generated first set of string edit actions and the generated second set of string edit actions.

11. The one or more computer-readable storage media according to claim 9, wherein the operations further comprising:
generating a node for each of the generated first set of string edit actions for the identified at least one first string in the first repair example of the first software program;
generating a first graph based on associations between the generated nodes for the generated first set of string edit actions;
generating a node for each of the generated second set of string edit actions for the identified at least one second string in the second repair example of the second software program; and
generating a second graph based on associations between the generated nodes for the generated second set of string edit actions.

12. The one or more computer-readable storage media according to claim 9, wherein the operations further comprising:
identifying a first plurality of strings in the first repair example of the first software program; and
generating a plurality of graphs based on each of the identified first plurality of strings.

13. The one or more computer-readable storage media according to claim 11, wherein the operations further comprising determining one or more common nodes based on the generated first graph and the second graph, wherein the determined one or more common nodes correspond to the determined one or more common string edit actions.

14. The one or more computer-readable storage media according to claim 9, wherein the operations further comprising:
determining a pairwise alignment associated with the at least one first string in the first repair example and the first violation of the first software program; and
generating the first set of string edit actions based on the determined pairwise alignment.

15. The one or more computer-readable storage media according to claim 9, wherein the first repair example includes the at least one first string and at least one first program code of the first software program.

16. An electronic device, comprising:
a processor configured to:
identify at least one first string in a first repair example and at least one second string in a second repair example, wherein the first repair example is configured to repair a first violation of a first software program, and the second repair example is configured to repair a second violation of a second software program, and wherein the first violation and the second violation are string-related violations;
generate a first set of string edit actions for the first software program based on the identified at least one first string in the first repair example and the first violation;
generate a second set of string edit actions for the second software program based on the identified at least one second string in the second repair example and the second violation;
determine one or more common string edit actions based on the generated first set of string edit actions and the generated second set of string edit actions; and
apply the determined one or more common string edit actions on a string-related third violation of a third software program to generate a repaired third software program.

17. The electronic device according to claim 16, wherein the processor is further configured to:
identify a first plurality of strings in the first repair example of the first software program;
identify a second plurality of strings in the second repair example of the second software program;
generate the first set of string edit actions for each of the identified first plurality of strings;
generate the second set of string edit actions for each of the identified second plurality of strings; and
determine the one or more common string edit actions based on the generated first set of string edit actions and the generated second set of string edit actions.

18. The electronic device according to claim 16, wherein the processor is further configured to:
generate a node for each of the generated first set of string edit actions for the identified at least one first string in the first repair example of the first software program; and
generate a first graph based on associations between the generated nodes for the generated first set of string edit actions;
generate a node for each of the generated second set of string edit actions for the identified at least one second string in the second repair example of the second software program; and
generate a second graph based on associations between the generated nodes for the generated second set of string edit actions.

19. The electronic device according to claim 16, wherein the processor is further configured to:
identify a first plurality of strings in the first repair example of the first software program; and
generate a plurality of graphs based on each of the identified first plurality of strings.

20. The electronic device according to claim 18, wherein the processor is further configured to determine one or more common nodes based on the generated first graph and the second graph, wherein the determined one or more common nodes correspond to the determined one or more common string edit actions.
